(19) United States
(12) Patent Application Publication
(10) Pub. No.: US 2012/0182851 A1
(43) Pub. Date: Jul. 19, 2012

(54) OPTICAL RECORDING MEDIUM AND RECORDING METHOD

(75) Inventors: Kimihiro Saito, Kanagawa (JP); Seiji Kobayashi, Kanagawa (JP); Junichi Horigome, Tokyo (JP); Toshihiro Horigome, Kanagawa (JP); Daisuke Ueda, Kanagawa (JP)

(73) Assignee: Sony Corporation, Tokyo (JP)

(21) Appl. No.: 13/499,299

(22) PCT Filed: Sep. 27, 2010
(86) PCT No.: PCT/JP2010/005793

§ 371 Date: Mar. 30, 2012

(30) Foreign Application Priority Data
Oct. 7, 2009 (JP) 2009-233194

(51) Int. Cl. G11B 7/0045; G11B 7/127; G11B 7/007

(52) U.S. Cl. 369/111; 369/100; 369/120; G9B/7.01; G9B/7.035; G9B/7.103

(57) ABSTRACT

Techniques for recording and reading information to/from a recording medium based on positions of a plurality of marks are described herein. Each of the plurality of marks may have the same length. The information may be recorded based on a mark interval between successive marks. Apparatus and a recording medium suitable for use with such techniques are also disclosed.

### TECHNICAL FIELD

The present invention relates to an optical recording medium in which information is recorded with a void mark and a recording method thereof.

### CITATION LIST

### Non Patent Literature

NPL 1: Y. Kasami, Y. Kuroda, K. Seo, O. Kawakubo, S. Takagawa, M. Ono, and M. Yamada, Jpn. J. Appl. Phys., 39, 756 (2000)
NPL 2: I. Ichimura et. al., Technical Digest of ISOM '04, pp 52, Oct. 11-15, 2005, Jeju Korea
NPL 3: M. Watanabe et. al., Jpn. J. Appl. Phys. Vol. 39 (2000) pp. 6763-6767
NPL 4: T. Mizuno et. al., Jpn. J. Appl. Phys. Vol. 45 (2006) pp. 1640-1647
NPL 5: K. Saito and S. Kobayashi: Proc. SPIE 6282 (2006) 628213

In optical disc systems such as a CD, a DVD, and a Blu-ray Disc (registered trademark), a minute change in reflectance of a light spot formed in one side of a disc is read in a noncontact manner like an objective lens of a microscope.

As is well known, a size of the light spot on the disc is given by about λ/NA (where λ is a wavelength of illumination light and NA is a numerical aperture), and resolution is also proportional to the value of λ/NA).

For example, Non-Patent Literature 1 describes the detailed Blu-ray Disc in which the disc having a diameter of 12 cm corresponds to about 25 GB.

### BACKGROUND ART

A method for forming plural recording layers in a depth direction of the disc and a method for increasing a capacity per one disc by performing recording in a multilayered manner in a bulk type (volume type) recording medium are also well known as described in Non-Patent Literatures 2, 3, and 4.

When the recording is performed in the bulk type recording medium, plastic having a refractive index of about 1.5 is illuminated with high-density light, and recording and reproduction are performed with a void filled with gas having a refractive index of about 1.0 as a mark.

On the other hand, as described in Non-Patent Literatures 2 and 5, in the multilayer recording, an interval between layers is set to about 10 μm or more, that is, 12.4n·λ/NA or more (where n is a medium refractive index, λ is a wavelength, and NA is an objective lens numerical aperture).

When the number of layers is increased to increase the capacity, it is necessary that spherical aberration generated by the medium (refractive index n) from a disc surface to a recording and reproducing layer be corrected by the system, and a capacity limit is determined by the design limit.

### SUMMARY

### Technical Problem

An object of the present invention is to realize a larger disc capacity within the spherical aberration correction limit in the method, in which the disc capacity is increased by the multilayered recording while the recording is performed by the void mark in the bulk type recording medium.

### Solution to Problem

Some embodiments relate to a method of recording information on a recording medium. The method includes forming a plurality of marks in a plurality of recording levels of the recording medium. Each of the plurality of marks has substantially a same length. The information is recorded based on positions of the plurality of marks. Some embodiments relate to a non-transitory computer-readable storage medium having recorded thereon instructions, which, when executed, perform the method of recording information on a recording medium. Some embodiments relate to an apparatus for recording information on a recording medium. The apparatus includes a controller that controls a laser to form a plurality of marks in a plurality of recording levels of the recording medium. Each of the plurality of marks has substantially a same length. The information is recorded based on positions of the plurality of marks.

Some embodiments relate to a method of reading information from a recording medium. The method includes generating a detection signal based on light received from a plurality of marks in a plurality of recording levels of the recording medium. Each of the plurality of marks has substantially a same length. The information is read based on positions of the plurality of marks. Some embodiments relate to a non-transitory computer-readable storage medium having recorded thereon instructions, which, when executed, perform the method of reading information from the recording medium. Some embodiments relate to an apparatus for reading information from a recording medium. The apparatus includes a processing unit that receives a detection signal generated based on light received from a plurality of marks in a plurality of recording levels of the recording medium. Each of the plurality of marks has substantially a same length. The processing unit reads the information based on positions of the plurality of marks.

Some embodiments relate to a recording medium that includes a plurality of marks in a plurality of recording levels of the recording medium. Each of the plurality of marks has substantially a same length. Information is encoded based on positions of the plurality of marks.

### Advantageous Effects of Invention

According to the present invention, the void mark string is recorded while the interval between the marks having the one type of the mark length is changed, so that the inter-layer thickness in the depth direction of the recording medium can be narrowed and the larger disc capacity can be realized within the spherical aberration correction limit.

### BRIEF DESCRIPTION OF DRAWINGS

FIG. 1 is an explanatory view of a recording medium according to an embodiment of the present invention.

FIG. 2 is an explanatory view of servo control for the recording medium of the embodiment

FIG. 3 is an explanatory view of a recording and reproducing optical system for the recording medium of the embodiment.

FIG. 4 is an explanatory view of mark position recording of the embodiment.

FIG. 5A is an explanatory view of an eye pattern in the mark position recording of the embodiment.

FIG. 5B is an explanatory view of a jitter in the mark position recording of the embodiment.

FIG. 6 is an explanatory view of mark edge recording according to a comparative example.

FIG. 7A is an explanatory view of an eye pattern in the mark edge recording of the comparative example.

FIG. 7B is an explanatory view of a jitter in the mark edge recording of the comparative example.

### DESCRIPTION OF EMBODIMENT

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

An embodiment of the present invention will be described below in the following order.

<1. Structure of Optical Recording medium of Embodiment>
<2. Servo Control during Recording and Reproduction>

### <3. Recording and Reproducing Optical System>

### <4. Mark Position Recording>

<1. Structure of Optical Recording Medium of Embodiment>

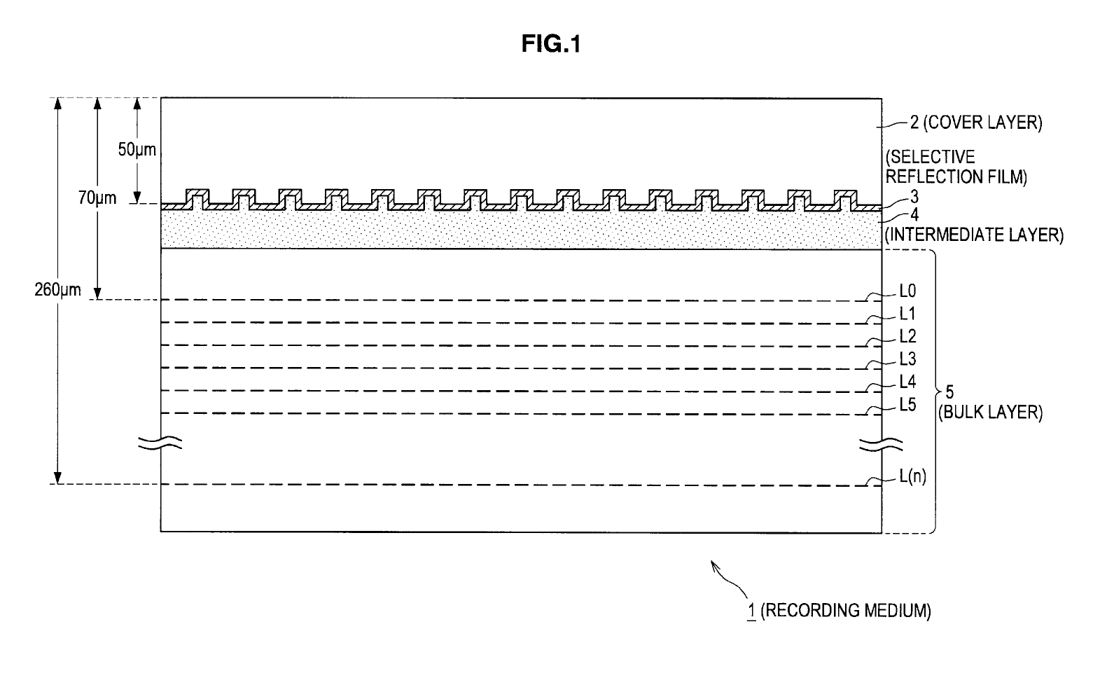

FIG. 1 illustrates a sectional structural diagram of an optical recording medium (recording medium 1) according to an embodiment of the present invention.

A disc-shaped optical recording medium is used as a recording medium 1 illustrated in FIG. 1, and the mark recording (information recording) is performed by illuminating the rotating recording medium 1 with a laser beam. The reproduction of the recording information is also performed by illuminating the rotating recording medium 1 with the laser beam.

As used herein, the optical recording medium refers to a recording medium in which the reproduction of the recording medium is performed by light illumination.

In the embodiment, the so-called void is formed as the recording mark.

The void recording method is a technique in which the void is recorded in a bulk layer by illuminating the bulk layer made of a recording material such as a photopolymerization photopolymer with the laser beam at relatively high power. The void portion formed by the void recording method constitutes a portion whose refractive index differs from that of another portion in the bulk layer, and the reflectance is enhanced in a boundary portion between both sides. Accordingly, the void portion acts as the recording mark, thereby realizing the information recording performed by the formation of the void mark.

Referring to FIG. 1, the recording medium 1 is a so-called bulk type optical recording medium, and a cover layer 2, a selective reflection film 3, an intermediate layer 4, and a bulk layer 5 are formed in the order from an upper layer side.

As used herein, in the description, the “upper layer side” refers to an upper layer side when a surface to which the laser beam is incident from a later-mentioned reproducing apparatus side.

A term of “depth direction” is used in the description, and the “depth direction” refers to a direction that is aligned with a vertical direction followed by a definition of the “upper layer side” (that is, a direction parallel to the direction in which the laser beam is incident from the reproducing apparatus side).

In the recording medium 1, the cover layer 2 is made of resin such as polycarbonate and acrylic, and an irregular sectional shape is provided in a lower surface side of the cover layer 2 in association with the formation of a guide groove that guides a recording/reproducing position as illustrated in FIG. 1. The guide groove is formed into a spiral shape when viewed in a disc plane direction.

The guide groove is formed by a continuous groove or a pit string. For example, when the guide groove is formed by the groove, the groove is formed in a periodically meandering manner, which allows positional information (absolute positional information such as information on a rotation angle and information in a radial position) to be recorded by the periodic information on the meandering.

The cover layer 2 is produced by injection molding using a stamper in which the guide groove (irregularity) is formed.

The selective reflection film 3 is deposited on the lower surface side of the cover layer 2 in which the guide groove is formed.

In the bulk recording method, it is assumed that, independently of recording light (hereinafter also referred to as a first laser beam) used to perform the mark recording, the bulk layer 5 that is the recording layer is illuminated with servo light (also referred to as a second laser beam) in order to obtain a tracking error signal and a focus error signal based on the guide groove.

At this point, when reaching the bulk layer 5, the servo light negatively affects the mark recording in the bulk layer 5. Therefore, there is a need of a reflection film having selectivity in which the servo light is reflected while the recording light is transmitted.

In the bulk recording method in related art, laser beams having different wavelengths are separately used as the recording light and the servo light, and a corresponding selective reflection film having the selectivity in which light having the same wavelength band as the servo light is reflected while light having another wavelength is transmitted is used as the selective reflection film 3.

The bulk layer 5 that is the recording layer is formed on the lower layer side of the selective reflection film 3 while the intermediate layer 4 made of an adhesive material such as a UV curing resin is interposed therebetween.

A material suitable to the void recording method may be used as the material (the recording material) for forming the bulk layer 5. For example, a plastic material is used as the bulk layer 5.

The laser beams successively focus on predetermined positions in the depth direction of the bulk layer 5, and the void mark is formed to perform the information recording to the bulk layer 5.

Accordingly, in the already-recorded recording medium 1, plural mark forming layers (information recording layers) L are formed in the bulk layer 5. In FIG. 1, many (n+1) information recording layers are formed as illustrated by information recording layer L0 to L(n).

A thickness of the bulk layer 5 is not definitive. However, for example, assuming that the bulk layer 5 is illuminated with a blue laser beam (a wavelength of 405 nm) through an optical system having NA of 0.85, the information recording layer is suitably formed at a position of 50 mm to 300 mm in the depth direction from the disc surface (the surface of the cover layer 2). The range is suitably obtained in consideration of the spherical aberration correction.

FIG. 1 illustrates an example in which the information recording layer is formed at the position of 70 mm to 260 mm from the disc surface.

Obviously, the number (n+1) of information recording layers is increased with narrowing inter-layer thickness. In some embodiments, the bulk recording medium may include twenty or more levels in which marks are formed to store information.

In each information recording layer, the recording is performed by the void mark while tracking servo is controlled using the guide groove formed in the cover layer 2. Accordingly, the void mark string formed in the information recording layer is formed into the spiral shape when viewed in the disc plane direction.

<2. Servo Control During Recording and Reproduction>

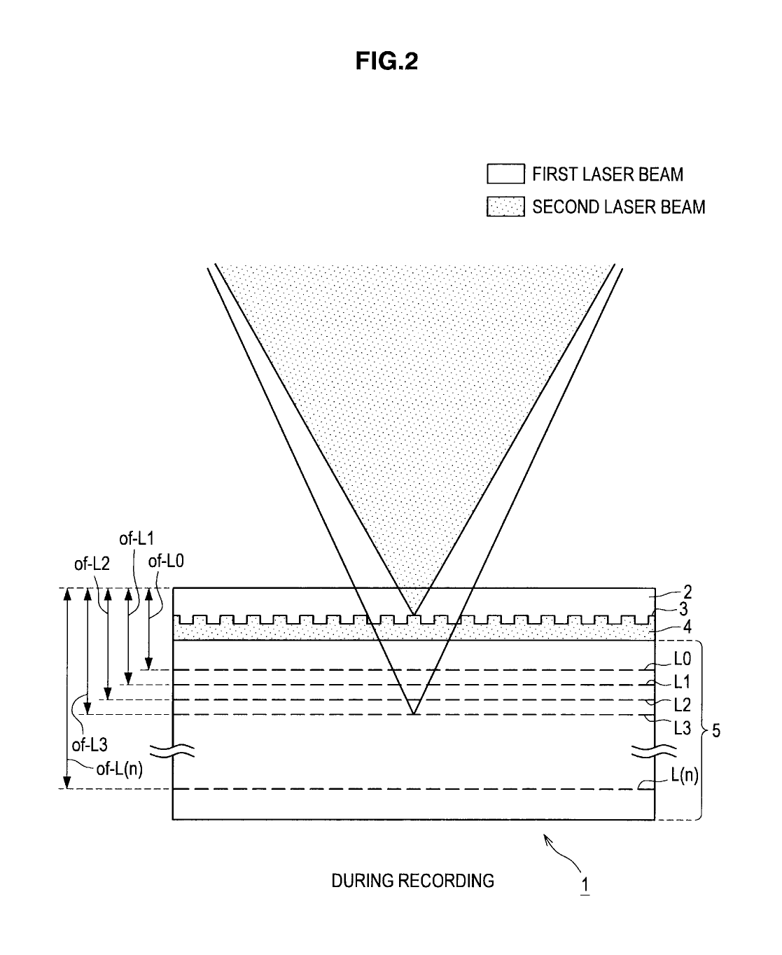

The servo control during the recording/reproduction aimed at the recording medium 1 that is the bulk type optical recording medium will be described with reference to FIG. 2.

As described above, the recording medium 1 is illuminated with not only the laser beam (the “first laser beam” in FIG. 2) that is used to form the recording mark and to reproduce the information from the recording mark but also the laser beam (the “second laser beam” in FIG. 2) that is the servo light having the different wavelength.

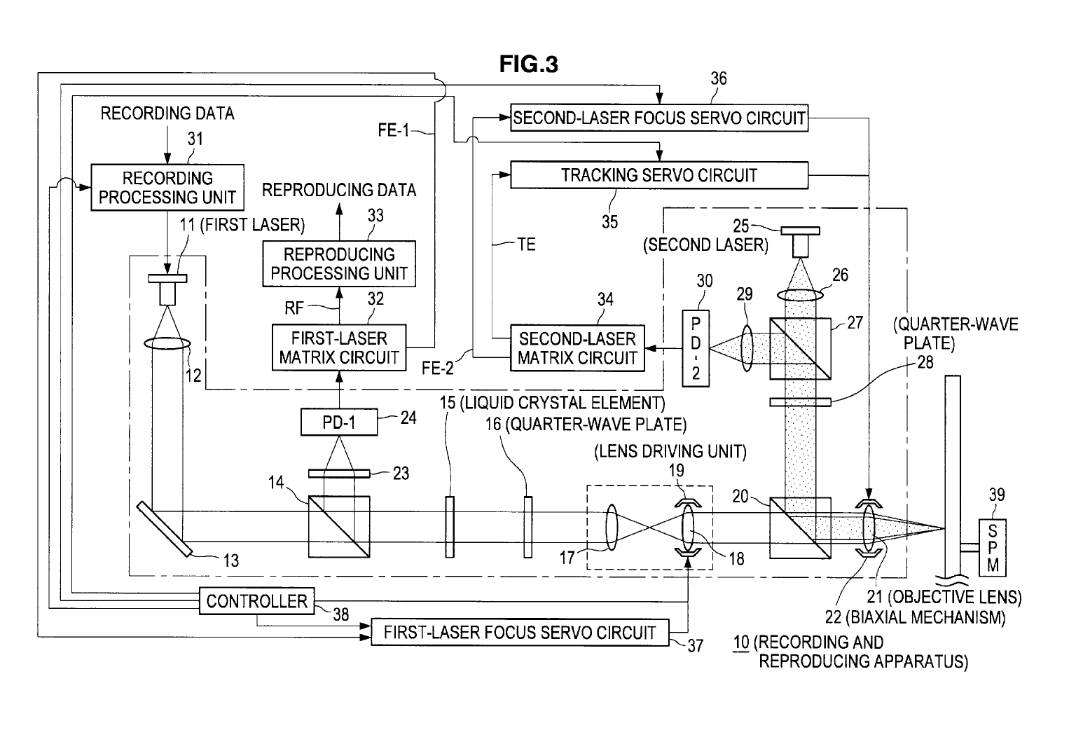

Although described later with reference to FIG. 3, the recording medium 1 is illuminated with the first laser beam and the second laser beam via a common objective lens (an objective lens 21 in FIG. 3).

At this point, as illustrated in FIG. 1, unlike the multi-layer disc that is the current optical disc such as the DVD (Digital Versatile Disc) and the Blu-ray Disc (registered trademark), a reflection surface having the guide groove such as the pit and the groove is not formed at a position of each layer that is the recording target in the bulk layer 5 of the recording medium 1. That is, during the recording in which the mark is not formed yet, the focus servo and tracking servo with the first laser beam are not able to be performed using the reflected light of the first laser beam.

Therefore, during the recording performed to the recording medium 1, the tracking servo and focus servo are performed to the first laser beam using the reflected light of the second laser beam that is the servo light.

Specifically, as to the focus servo of the first laser beam during the recording, a first-laser-beam focus mechanism (lenses 17 and 18 and a lens driving unit 19 in FIG. 3) is provided such that only a focus position of the first laser beam can independently be changed. The first-laser-beam focus mechanism is controlled using an offset of based on the selective reflection film 3 (guide groove forming surface) illustrated in FIG. 2, thereby performing the focus servo.

At this point, as described above, the recording medium 1 is illuminated with the first laser beam and the second laser beam via the common objective lens. The focus servo of the second laser beam is performed by controlling the objective lens using the second laser beam reflected from the selective reflection film 3.

The recording medium 1 is illuminated with the first laser beam and the second laser beam via the common objective lens, and the focus servo of the second laser beam is performed by controlling the objective lens based on the second laser beam reflected from the selective reflection film 3, whereby the focus position of the first laser beam basically follows the selective reflection film 3. In other words, a function of following a surface fluctuation of the recording medium 1 with respect to the focus position of the first laser beam is provided by the focus servo of the objective lens based on the second laser beam reflected from the selective reflection film 3.

Additionally, the focus position of the first laser beam is offset by the value of the offset of using the first-laser-beam focus mechanism. Therefore, the focus position of the first laser beam can follow the necessary depth position in the bulk layer 5.

FIG. 2 illustrates an example in which offsets of corresponding to the information recording layers L0 to L(n) are set in the bulk layer 5. That is, FIG. 2 illustrates the case in which an offset of-L0 corresponding to the layer position of the information recording layer L0, an offset of-L1 corresponding to the layer position of the information recording layer L1, . . . , and an offset of-L(n) corresponding to the layer position of the information recording layer L(n) are set.

The mark forming position (recording position) in the depth direction can appropriately be selected from the layer position of the information recording layer L0 to the layer position of the information recording layer L(n) by driving the first-laser focus mechanism using the values of offsets of.

As to the tracking servo of the first laser beam during the recording, using the point that the recording medium 1 is illuminated with the first laser beam and the second laser beam via the common objective lens as described above, the tracking servo of the objective lens is performed with the second laser beam reflected from the selective reflection film 3, thereby realizing the tracking servo of the first laser beam.

On the other hand, during the reproduction, the information recording layer L is formed in the bulk layer 5 as illustrated in FIG. 1, so that the first laser beam reflected from the information recording layer L can be obtained. Therefore, during the reproduction, the focus servo of the first laser beam is performed by utilizing the reflected light of the first laser beam.

Specifically, the focus servo of the first laser beam during the reproduction is performed by controlling the first-laser-beam focus mechanism based on the reflected light of the first laser beam.

Even during the reproduction, the tracking servo of the first laser beam is realized by performing the tracking servo of the objective lens based on the reflected light of the second laser beam.

At this point, even during the reproduction, the focus servo and tracking servo of the second laser beam are performed for the guide groove forming surface (guide groove) in order to read the absolute positional information recorded in the guide groove forming surface that is the selective reflection film 3.

That is, during the reproduction, similarly to the recording, the position of the objective lens is controlled such that the focus servo and tracking servo of the second laser beam are realized for the guide groove forming surface (guide groove) based on the reflected light of the second laser beam.

In the embodiment, the servo control is performed as follows.

—First Laser Beam Side

During the recording: The common objective lens is driven using the reflected light of the second laser beam, and the offset is provided using the first-laser-beam focus mechanism, thereby performing the focus servo (the tracking servo is automatically performed by driving the objective lens using the reflected light of the second laser beam).

During the reproduction: The focus servo is performed by driving the first-laser-beam focus mechanism using the reflected light of the first laser beam (during the reproduction, the tracking servo of the first laser beam is also automatically performed by driving the objective lens using the reflected light of the second laser beam).

—Second Laser Beam Side

During both the recording and the reproduction, the focus servo and the tracking servo are performed by driving the objective lens using the reflected light of the second laser beam.

<3. Recording and Reproducing Optical System>

FIG. 3 illustrates a configuration of a recording and reproducing apparatus 10 that performs the recording and reproduction to the recording medium 1 of FIG. 1.

First, the recording medium 1 loaded in the recording and reproducing apparatus 10 is rotated by a spindle motor (SPM) 39 of FIG. 3.

An optical pickup OP is provided in the recording and reproducing apparatus 10 in order to illuminate the rotated recording medium 1 with the first laser beam and the second laser beam.

A first laser 11 that is a light source of the first laser beam and a second laser 25 that is a light source of the second laser beam as the servo light are provided in the optical pickup OP. The first laser 11 is used to record the information by the formation of the void mark and to reproduce the information recorded by the void mark.

As described above, the first laser beam differs from the second laser beam in the wavelength. In the embodiment, the first laser beam has the wavelength of about 405 nm (a so-called blue-violet laser beam), and the second laser beam has the wavelength of about 660 nm (a red laser beam).

An objective lens 21 that constitutes output ends of the first laser beam and second laser beam with respect to the recording medium 1 is provided in the optical pickup OP. The objective lens 21 has NA of 0.85.

A first photodetector (PD-1 in FIG. 3) 24 that receives the first laser beam reflected from the recording medium 1 and a second photodetector (PD-2 in FIG. 3) 30 that receives the second laser beam reflected from the recording medium 1 are also provided in the optical pickup OP.

Additionally, an optical system is provided in the optical pickup OP. The optical system guides the first laser beam emitted from the first laser 11 to the objective lens 21, and the optical system guides the reflected light of the first laser beam, which is incident from the recording medium 1 to the objective lens 21, to the first photodetector 24.

Specifically, after the first laser beam emitted from the first laser 11 is shaped into parallel light via a collimation lens 12, an optical axis of the first laser beam is bent by 90 degrees by a minor 13, and the first laser beam is incident to a polarization beamsplitter 14. The polarization beamsplitter 14 is configured to transmit the first laser beam that is emitted from the first laser 11 and is incident to the polarization beamsplitter 14 via the minor 13.

The first laser beam transmitted through the polarization beamsplitter 14 passes through a liquid crystal element 15 and a quarter-wave plate 16.

At this point, the liquid crystal element 15 is provided in order to correct off-axis aberrations such as coma aberration and astigmatism.

The first laser beam passing through the quarter-wave plate 16 is incident to an expander that includes a lens 17 and a lens 18. In the expander, the lens 17 located on the side closer to the first laser 11 that is the light source constitutes a fixed lens, and the lens 18 located on the side farther away from the first laser 11 constitutes a movable lens. The lens 18 is driven in the direction parallel to the optical axis of the first laser beam by a lens driving unit 19 in FIG. 3, thereby performing the independent focus control to the first laser beam.

During the recording, the expander (the lens driving unit 19) offsets the focus position of the first laser beam based on an instruction of a controller 38. During the reproduction, the expander performs the focus control of the first laser beam based on a signal output from a first-laser focus servo circuit 37.

The first laser beam via the expander is incident to a dichroic mirror 20. The dichroic mirror 20 is configured such that the light having the same wavelength band as the first laser beam is transmitted while the light having another wavelength band is reflected. Accordingly, the first laser beam incident in the above-described way is transmitted through the dichroic minor 20.

The recording medium 1 is illuminated with the first laser beam transmitted through the dichroic minor 20 via an objective lens 21.

A biaxial mechanism 22 is provided for the objective lens 21. The biaxial mechanism 22 retains the objective lens 21 while the objective lens 21 can be displaced in the focus direction (the direction in which the objective lens 21 comes close to and moves away from the recording medium 1) and the tracking direction (the direction orthogonal to the focus direction: the radial direction of the recording medium 1).

In the biaxial mechanism 22, a second-laser focus servo circuit 36 and a tracking servo circuit 35 provide driving currents to a focus coil and a tracking coil, respectively, thereby displacing the objective lens 21 in the focus direction and the tracking direction.

During the reproduction, the recording medium 1 is illuminated with the first laser beam as described above, whereby the first laser beam reflected from the recording medium 1 (particularly the information recording layer L of the reproducing target in the bulk layer 5) is obtained. The obtained reflected light of the first laser beam is guided to the dichroic minor 20 via the objective lens 21 to transmit through the dichroic mirror 20.

After the reflected light of the first laser beam, which is transmitted through the dichroic mirror 20, passes through the lenses 18 and 17 constituting the expander, and the reflected light is incident to the polarization beamsplitter 14 via the quarter-wave plate 16 and the liquid crystal element 15.

A polarized direction of the reflected light (return light) of the first laser beam, which is incident to the polarization beamsplitter 14, is different from a polarized direction of the first laser beam (approach light), which is incident to the polarization beamsplitter 14 from the side of the first laser beam 11, by 90 degrees due to action of the quarterwave plate 16 and reflection action at the recording medium 1. As a result, the reflected light of the first laser beam is reflected by the polarization beamsplitter 14 as described above.

The reflected light of the first laser beam, which is reflected by the polarization beamsplitter 14, is guided onto a side of a collective lens 23 in FIG. 3. The collective lens 23 collects the reflected light of the first laser beam onto a detection surface of the first photodetector 24.

Additionally, an optical system is provided in the optical pickup OP. The optical system guides the second laser beam emitted from the second laser 25 to the objective lens 21, and the optical system guides the reflected light of the second laser beam, which is incident from the recording medium 1 to the objective lens 21, to the second photodetector 30.

As illustrated in FIG. 3, the second laser beam emitted from the second laser 25 is incident to a polarization beamsplitter 27 after shaped into parallel light via a collimation lens 26. The polarization beamsplitter 27 is configured to transmit the second laser beam (approach light) that is incident to the polarization beamsplitter 27 via the second laser 25 and the collimation lens 26.

The second laser beam transmitted through the polarization beamsplitter 27 is incident to the dichroic mirror 20 via a quarter-wave plate 28.

As described above, the dichroic mirror 20 is configured such that the light having the same wavelength band as the first laser beam is transmitted while the light having another wavelength band is reflected. Accordingly, the second laser beam is reflected by the dichroic mirror 20, and the recording medium 1 is illuminated with the second laser beam via the objective lens 21.

The reflected light (light reflected from the selective reflection film 3) of the second laser beam, which is obtained by illuminating the recording medium 1 with the second laser beam, is incident to the polarization beamsplitter 27 after reflected by the dichroic mirror 20 via the objective lens 21 and the quarter-wave plate 28.

Similarly to the first laser beam, the polarized direction of the reflected light (return light) of the second laser beam, which is incident from the side of the recording medium 1, is different from the polarized direction of the approach light by 90 degrees due to the action of the quarter-wave plate 28 and the reflection action at the recording medium 1. Accordingly, the reflected light of the second laser beam that is the return light is reflected by the polarization beamsplitter 27.

The reflected light of the second laser beam, which is reflected by the polarization beamsplitter 27, is collected onto a detection surface of a second photodetector 30 via a collective lens 29.

Although not illustrated, actually a slide driving unit that slides the whole of the optical pickup OP in the tracking direction is provided in the recording and reproducing apparatus 10, and the slide driving unit drives the optical pickup OP such that the laser beam illuminating position is widely displaced.

A recording processing unit 31, a first-laser matrix circuit 32, a reproducing processing unit 33, a second-laser matrix circuit 34, the tracking servo circuit 35, the second-laser focus servo circuit 36, the first-laser focus servo circuit 37, and the controller 38 are provided in the recording and reproducing apparatus 10 in addition to the optical pickup OP and the spindle motor 39.

First, data (recording data) that should be recorded in the recording medium 1 is input to the recording processing unit 31. The recording processing unit 31 performs addition of an error correction code, coding of predetermined recording modulation, and the like to the input recording data, thereby obtaining a recording modulation data string that is a binary data string of “0” and “1” actually recorded in the recording medium 1.

In response to the instruction of the controller 38, the recording processing unit 31 drives the first laser 11 such that the first laser 11 emits the light based on the produced recording modulation data string.

The first-laser matrix circuit 32 includes a current-voltage conversion circuit and a matrix computation/amplification circuit according to currents output from plural light-receiving elements that are the first photodetector 24, and the first-laser matrix circuit 32 produces a necessary signal through matrix computation processing.

Specifically, the first-laser matrix circuit 32 produces a high-frequency signal (hereinafter referred to as reproducing signal RF) corresponding to a reproducing signal obtained by reproducing the recording modulation data string and a focus error signal FE for the focus servo control.

In the embodiment, there are two types of the focus error signals FE, that is, a focus error signal FE based on the reflected light of the first laser beam and the reflected light of the second laser beam. In order to distinguish the two types of the focus error signals FE from each other, the focus error signal FE produced by the first-laser matrix circuit 32 is referred to as a focus error signal FE-1.

The reproducing signal RF produced by the first-laser matrix circuit 32 is supplied to the reproducing processing unit 33.

The focus error signal FE-1 is supplied to the first-laser focus servo circuit 37.

The reproducing processing unit 33 performs reproducing processing such as binarization processing and decoding/error correction processing of the recording modulation code to the reproducing signal RF produced by the first-laser matrix circuit 32 in order to restore the recording data, thereby obtaining reproducing data in which the recording data is reproduced.

The first-laser focus servo circuit 37 produces a focus servo signal based on the focus error signal FE-1, and the first-laser focus servo circuit 37 controls the drive of the lens driving unit 19 based on the focus servo signal, thereby performing the focus servo control to the first laser beam.

As can be seen from the above description, during the reproduction, the focus servo control of the first laser beam is performed by driving the lens driving unit 19 based on the reflected light of the first laser beam.

In response to the corresponding instruction provided from the controller 38 during the reproduction, the first-laser focus servo circuit 37 controls the drive of the lens driving unit 19 while an inter-layer jump operation between the information recording layers L formed in the recording medium 1 and leading of the necessary information recording surface L to the focus servo are performed.

On the second laser beam side, the second-laser matrix circuit 34 includes a current-voltage conversion circuit and a matrix computation/amplification circuit according to currents output from plural light-receiving elements that are the second photodetector 30, and the second-laser matrix circuit 34 produces a necessary signal through the matrix computation processing.

Specifically, the second-laser matrix circuit 34 produces a focus error signal FE-2 for the servo control and a tracking error signal TE.

The focus error signal FE-2 is supplied to the second-laser focus servo circuit 36, and the tracking error signal TE is supplied to the tracking servo circuit 35.

The second-laser focus servo circuit 36 produces the focus servo signal based on the focus error signal FE-2, and the focus coil of the biaxial mechanism 22 is driven based on the focus servo signal, thereby performing the focus servo control to the objective lens 21. As described above, during both the recording and the reproduction, the focus servo control of the objective lens 21 is performed based on the reflected light of the second laser beam.

In response to the instruction from the controller 38, the second-laser focus servo circuit 36 drives the focus coil while the selective reflection film 3 (guide groove forming surface) formed in the recording medium 1 is led to the focus servo.

The tracking servo circuit 35 produces the tracking servo signal based on the tracking error signal TE from the second laser matrix circuit 34, and the tracking coil of the biaxial mechanism 22 is driven based on the tracking servo signal. As described above, during both the recording and the reproduction, the tracking servo control of the objective lens 21 is performed based on the reflected light of the second laser beam.

For example, the controller 38 is formed by a microcomputer including a CPU (Central Processing Unit) and a memory (storage device) such as a ROM (Read Only Memory), and the controller 38 performs the control and processing according to a program stored in the ROM to wholly control the recording and reproducing apparatus 10.

During the recording, the controller 38 controls (selects the recording position in the depth direction) the focus position of the first laser beam based on the value of the offset of that is set according to each layer position as described in FIG. 2. That is, the controller 38 drives the lens driving unit 19 based on the value of the offset of that is set according to the layer position of the recording target, thereby selecting the recording position in the depth direction.

The value of the offset of is stored in the ROM, a flash memory, and the like of controller 38. The positions of the information recording layers L0 to L(n) are set by the settings of the values of the offsets of-L0 to of-L(n). In other words, inter-layer thicknesses of the information recording layers L0 to L(n) are also determined.

As described above, during the recording, the tracking servo control is performed based on the reflected light of the second laser beam. Therefore, during the recording, the controller 38 provides an instruction to perform the tracking servo control based on the tracking error signal TE to the tracking servo circuit 35.

During the recording, the controller 38 provides an instruction to perform the focus servo control (the focus servo control with respect to the objective lens 21) based on the focus error signal FE-2 to the second-laser focus servo circuit 36.

On the other hand, during the reproduction, the controller 38 provides an instruction to the first-laser focus servo circuit 37 to focus the first laser beam onto the information recording layer L in which the data that should be reproduced is recorded. That is, the focus servo control of the first laser beam is performed for the information recording layer L.

Even during the reproduction, the controller 38 causes the tracking servo circuit 35 to perform the tracking servo control based on the tracking error signal TE.

During the reproduction, the controller 38 causes the second-laser focus servo circuit 36 to perform the focus servo control (the focus servo control with respect to the objective lens 21) based on the focus error signal FE-2.

Although the description with the drawing is omitted, the absolute positional information recorded in the selective reflection film 3 (guide groove forming surface) is read based on the reflected light of the second laser beam. Therefore, actually the second-laser matrix circuit 34 produces the reproducing signal for the signal recorded in the guide groove forming surface. For example, a sum signal of RF signals is produced when the information is recorded by the pit string, and a push-pull signal is produced when the information is recorded by a wobbling groove. A positional information detecting unit that detects the absolute positional information based on the reproducing signal is provided with respect to the recording signal.

<4. Mark Position Recording>

As described above with reference to FIG. 1, in the recording medium 1 of the embodiment, many information recording layers L in which the void mark string is recorded into the spiral shape are formed in the depth direction. In the embodiment, the void mark string is recorded by changing a mark interval of the one type of the mark length. That is, the embodiment is the so-called mark position recording in which the information is recorded by changing each recording mark interval while the length of the recording mark is set to one type.

The guide groove is formed into the spiral shape in the cover layer 2. When the recording is performed while the tracking is performed by the guide groove, the information is recorded in a planar state in the bulk layer 5 to form the information recording layer L. That is, the void mark string is formed into the spiral shape.

After one information recording layer is recorded, the expander (lens 18) is driven based on the value of the offset of to control the focus position of the first laser, thereby performing the recording in another information recording layer.

In the embodiment, the void mark is recorded by the mark position recording.

The information recording method is roughly classified into a method (mark edge recording) for changing a mark length and a mark interval and a method (mark position recording), which is adopted in the embodiment, for changing an interval of the one type of mark.

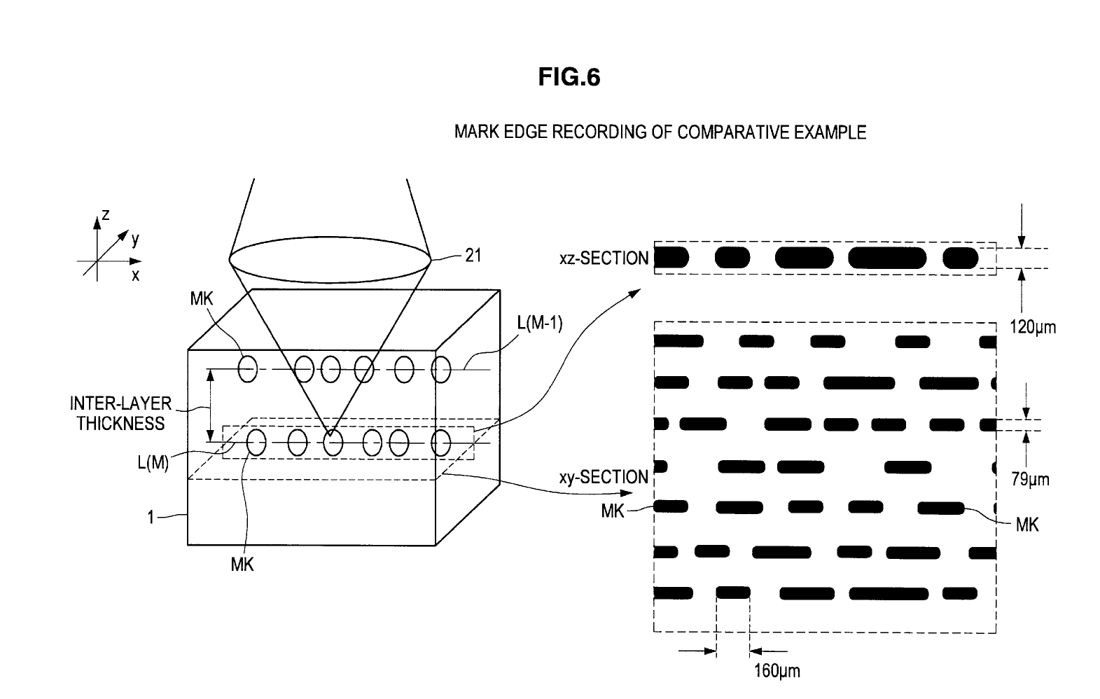

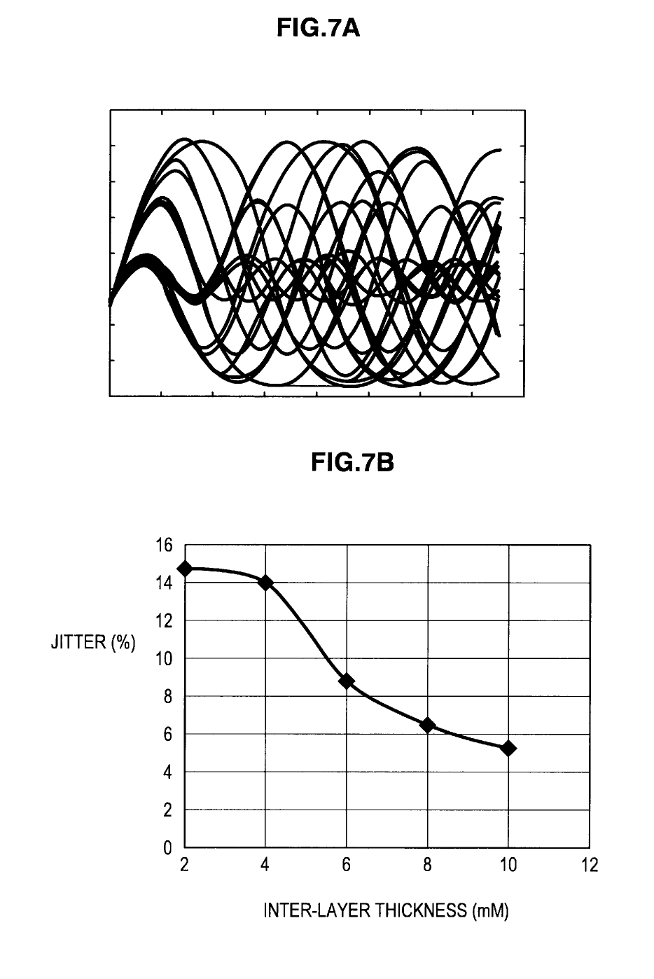

For the purpose of comparison, the case in which the mark edge recording is performed will be described with reference to FIGS. 6 and 7.

(1,7) RLL modulation mark edge recording that is used in the Blu-ray Disc can be cited as an example of the mark edge recording.

FIG. 6 schematically illustrates the case in which the recording is performed in two information recording layers L(M-1) and L(M) of the recording medium 1 (bulk layer 5). The right of FIG. 6 illustrates an xz-section and an xy-section of the information recording layer L(M) that is located on the back side when viewed from the laser incident side. In the schematic diagram on the left of FIG. 6, an ellipsoid and a black long hole portion in each section are a void mark MK.

The void mark MK has a width of 79 mm and a height of 120 mm. Because of the mark edge recording, the mark length depends on the recording data. For example, assuming that a channel bit length is 84 nm, the length of the void mark MK is modulated by the mark and space length of 2T (two clocks) to 8T lengths. A track pitch is 0.32 mm.

FIG. 7-A illustrates an eye pattern during the reproduction of the information recording layer L(M). Because of the mark edge recording, amplitude is obtained according to the mark lengths (2T to 8T).

FIG. 7-B illustrates computation result of a jitter of the information recording layer L(M) in changing an inter-layer thickness between the information recording layer L(M) and the information recording layer L(M-1). A jitter value that is a temporal fluctuation (normalized by channel bit length) of the signal at a threshold level in digitalizing the reproducing signal is plotted in FIG. 7-B.

As can be seen from the result of FIG. 7-B, the jitter degrades rapidly from the inter-layer thickness of about 8 μm or less. When the upper information recording layer L(M-1) is eliminated, the jitter is substantially identical to that of the inter-layer thickness of 10 μm.

Actually, the jitter is preferably lower than about 5.7 to about 5.8%. From the viewpoint of jitter value, it is believed that 12.4nλ/NA is a lower limit of the inter-layer thickness in the multilayer recording. Where n is a medium refractive index, λ is a wavelength of the first laser beam, and NA is a numerical aperture of the objective lens 21.

12.4nλ/NA=9.45 μm is obtained when the wavelength λ is set to 405 nm, the NA is set to 0.85, and the medium refractive index is set to 1.6.

That is, when the information recording layers L0 to L(n) are formed as illustrated in FIG. 1, preferably the inter-layer thickness of each information recording layer is 9.45 or more.

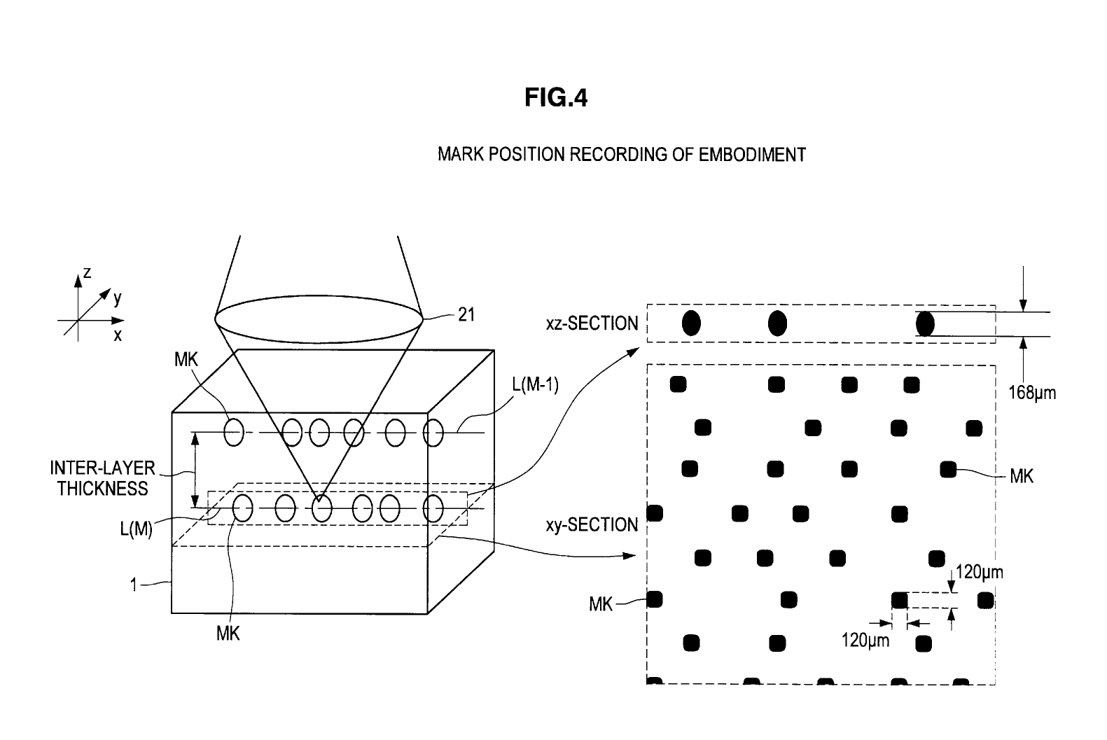

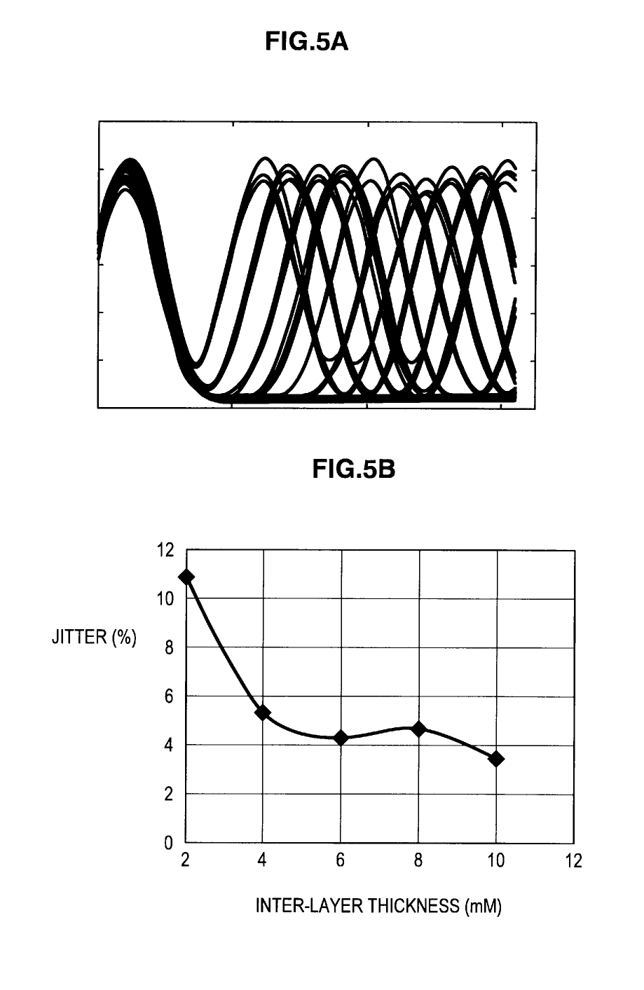

On the other hand, FIGS. 4 and 5 illustrate the mark position recording method of the embodiment. FIGS. 4 and 5 illustrate the case in which the mark position recording is performed by VFM (Variable Five Modulation) modulation.

Similarly to FIG. 6, FIG. 4 schematically illustrates the case in which the void marks MK are recorded in the two information recording layers L(M-1) and L(M) of the recording medium 1 (bulk layer 5). The right of FIG. 4 illustrates the xz-section and the xy-section of the information recording layer L(M) that is located on the back side when viewed from the laser incident side.

The void mark MK has the width of 120 mm, the length of 120 mm, and the height of 168 mm.

The channel bit length is similarly set to 84 nm. In the VFM modulation, the mark shape is identical, and a distance between the marks is changed from 5 to 16 channel bit lengths. The track pitch is 0.32 mm.

FIG. 5-A illustrates an eye pattern during the reproduction of the information recording layer L(M). The amplitude is obtained according to the single mark length.

Similarly to FIG. 7-B, FIG. 5-B illustrates computation result of the jitter of the information recording layer L(M) in changing the inter-layer thickness between the information recording layer L(M) and the information recording layer L(M-1). At this point, the jitter is obtained by plotting a fluctuation in peak time of the reproducing signal.

The jitter degrades rapidly from the inter-layer thickness of about 5 mm or less. When the upper information recording layer L(M-1) is eliminated, the jitter is substantially identical to that of the inter-layer thickness of 10 mm.

As can be seen from the result of FIG. 5-B, the jitter exists within a permissible value until the inter-layer thickness is about 4 μm.

As described above, for the mark edge recording, it is believed that the lower limit of the inter-layer thickness is 12.4nλ/NA. For the mark position recording, the lower limit of the jitter (jitter is about 5.7 to 5.8%) that becomes identical to that of the mark edge recording can be set to 5.2nλ/NA.

5.2nλ/NA=4 μm is obtained under the same conditions that the wavelength λ is set to 405 nm, the NA is set to 0.85, and the medium refractive index is set to 1.6.

That is, in performing the mark position recording, when the information recording layers L0 to L(n) are formed as illustrated in FIG. 1, the inter-layer thickness of each information recording layer can narrowly be set to 9.45 μm or less, for example, about 4 μm at the minimum.

That is, some or all the recording layer intervals can be set in the range of 5.2nλ/NA to 12.4nλ/NA.

It is assumed that the information recording layer is formed in the range of 70 mm to 260 mm from the surface like the example of FIG. 1.

When the mark edge recording is adopted to set all the inter-layer thicknesses to 10 mm, 15 information recording layers can be formed in the range of 70 mm to 260 mm from the surface.

On the other hand, when the mark position recording is adopted like the embodiment to set all the inter-layer thicknesses to 5 mm, 39 information recording layers can be formed in the range of 70 mm to 260 mm from the surface.

Only by way of example, in the embodiment, it can be understood that the optical recording medium, in which the many recording layers in which the void marks are recorded into the spiral shape are formed in the depth direction and the void marks are recorded while the interval of the one type of mark length is changed, is provided to be able to considerably extend the recording capacity. For example, when all the interlayer thicknesses are set to 4 mm using the range of 50 mm to 300 mm from the surface, more information recording layers can be formed to achieve the larger capacity.

Therefore, the low-cost, large-capacity recording and reproducing optical disc system having many information recording layers can be implemented.

It is not necessary that all the inter-layer thicknesses are unified, but some of the inter-layer thicknesses may be set in the range of 5.2nλ/NA to 12.4nλ/NA.

Particularly, in order to remove an influence of inter-layer stray light (a reflected light component in the information recording layer that is not the recording and reproducing target), the inter-layer thicknesses are effectively varied, and each inter-layer thickness may be set in consideration of the whole capacity (numbers of layers) or the removal of the influence of the inter-layer stray light.

In the recording and reproducing apparatus 10 illustrated in FIG. 3, the recording processing unit 31 causes the first laser 11 to perform the laser modulation to realize the mark position recording by, for example, the VFM modulation method. The controller 38 stores the offsets of-L1 to of-L(n) corresponding to the information recording layers L0 to L(n) therein according to the set inter-layer thicknesses in order to perform the recording to each of the information recording layers L0 to L(n). In order to perform the recording of the target information recording layer, the controller 38 controls the lens 18 (lens driving unit 19) of the expander. Therefore, the focus control is performed to form the target information recording layer, and each of the information recording layers L0 to L(n) can be formed with the resultant inter-layer thickness.

When the reproduction of the recording medium 1 is performed, the controller 38 controls the lens 18 (lens driving unit 19) of the expander according to the offset of the target information recording layer in the offsets of-L1 to of-L(n). Therefore, the focus control is performed to reproduce the target information recording layer, the information of the void mark string recorded by the mark position recording can be read from the information recording layer.

In the present invention, the void mark is properly formed based on the modulation signal using a variable-length code whose minimum run is 4 or more. The VFM is one of the corresponding modulation methods.

Generally, there is well known a block code as one of data modulation methods suitable to the transmission or recording. In the block code, the data string is blocked in units of m*i bits (hereinafter referred to as a data word), and the data word is converted into a code word including n*i bits according to a proper coding rule. The fixed-length code is obtained in the case of i=1, and the variable-length code when plural value of i (i is 1 or more) are selected, that is, when the conversion is performed by imax=r that is the maximum value of i.

The block-coded code is called the variable-length code (d,k;m,n;r). Where i is called a constraint length, and the constraint length imax becomes r (hereinafter referred to as maximum constraint length r). d designates the minimum continuous number of identical symbols, that is, the so-called minimum run of, for example, zero, and k designates the maximum continuous number of identical symbols, that is, the so-called maximum run of, for example, zero. The VFM is the variable-length code (4,22;2,5;5). The present invention is not limited to the VFM, but the variable-length code whose minimum run is 4 or more is preferably used.

It should be understood by those skilled in the art that various modifications, combinations, sub-combinations and alterations may occur depending on design requirements and other factors insofar as they are within the scope of the appended claims or the equivalents thereof.

The present application contains subject matter related to that disclosed in Japanese Priority Patent Application JP 2009-233194 filed in the Japan Patent Office on Oct. 7, 2009, the entire content of which is hereby incorporated by reference.

### REFERENCE SIGNS LIST

1 Recording medium
2 Cover layer
3 Selective reflection film
4 Intermediate layer
5 Bulk layer
L0 to L(n) Information recording layer
MK Void mark

1. A method of recording information on a recording medium, the method comprising:
forming a plurality of marks in a plurality of recording levels of the recording medium, wherein each of the plurality of marks has substantially a same length, wherein the information is recorded based on positions of the plurality of marks.

2. The method of claim 1, wherein the plurality of marks are formed in a spiral pattern.

3. The method of claim 1, wherein forming the plurality of marks comprises forming a plurality of voids in the recording medium using a laser.

4. The method of claim 1, wherein at least one of distances between successive recording levels is between 5.2nλ/NA and 12.4nλ/NA, wherein n is a refractive index of a material forming the recording medium, λ is a wavelength of light emitted by a laser that forms the plurality of marks, and NA is a numerical aperture of an optical system through with the laser records the information.

5. The method of claim 1, wherein at least one of distances between successive recording levels is between 4 mm and 9.45 mm.

6. The method of claim 1, wherein the plurality of recording levels are formed between 50 mm and 300 mm from an upper surface of the recording medium.

7. The method of claim 1, wherein the recording medium comprises an optical disc.

8. The method of claim 1, wherein the plurality of marks are formed in twenty or more levels of the recording medium.

9. The method of claim 1, wherein the information is recorded based on a mark interval between successive marks.

10. The method of claim 1, wherein the information is recorded based on a modulation signal produced by a variable length code having a minimum run of four or more.

11. The method of claim 1, wherein the recording medium comprises a bulk recording medium.

12. A non-transitory computer-readable storage medium having recorded thereon instructions, which, when executed, perform a method of recording information on a recording medium, the method comprising:
forming a plurality of marks in a plurality of recording levels of the recording medium, wherein each of the plurality of marks has substantially a same length, wherein the information is recorded based on positions of the plurality of marks.

13. The non-transitory computer-readable storage medium of claim 12, wherein the information is recorded based on a mark interval between successive marks.

14. The non-transitory computer-readable storage medium of claim 12, wherein the information is recorded based on a modulation signal produced by a variable length code having a minimum run of four or more.

15. An apparatus for recording information on a recording medium, the apparatus comprising:
a controller that controls a laser to form a plurality of marks in a plurality of recording levels of the recording medium, wherein each of the plurality of marks has substantially a same length, wherein the information is recorded based on positions of the plurality of marks.

16. The apparatus of claim 15, further comprising:
a laser that forms the plurality of marks.

17. The apparatus of claim 16, wherein the laser forms a plurality of voids in the recording medium.

18. The apparatus of claim 16, wherein at least one of distances between successive recording levels is between 5.2nλ/NA and 12.4nλ/NA, wherein n is a refractive index of a material forming the recording medium, λ, is a wavelength of light emitted by the laser, and NA is a numerical aperture of an optical system through with the laser records the information.

19. The apparatus of claim 15, wherein the plurality of marks are formed in twenty or more levels of the recording medium.

20. The apparatus of claim 15, wherein the recording medium comprises an optical disc.

21. The apparatus of claim 15, wherein the information is recorded based on a mark interval between successive marks.

22. The apparatus of claim 15, wherein the information is recorded based on a modulation signal produced by a variable length code having a minimum run of four or more.

23. An apparatus for reading information from a recording medium, the apparatus comprising:
a processing unit that receives a detection signal generated based on light received from a plurality of marks in a plurality of recording levels of the recording medium, wherein each of the plurality of marks has substantially a same length, wherein the processing unit reads the information based on positions of the plurality of marks.

24. The apparatus of claim 23, further comprising a laser that emits light to the plurality of marks.

25. The apparatus of claim 23, wherein the recording medium comprises an optical disc.

26. The apparatus of claim 23, wherein the information is read based on a mark interval between successive marks.

27. A method of reading information from a recording medium, the method comprising:
generating a detection signal based on light received from a plurality of marks in a plurality of recording levels of the recording medium,
wherein each of the plurality of marks has substantially a same length, wherein the information is read based on positions of the plurality of marks.

28. The method of claim 27, wherein the information is read based on a mark interval between successive marks.

29. The method of claim 27, wherein the recording medium comprises a bulk recording medium.

30. A non-transitory computer-readable storage medium having recorded thereon instructions, which, when executed, perform a method of reading information from a recording medium, the method comprising:
generating a detection signal generated based on light received from a plurality of marks in a plurality of recording levels of the recording medium, wherein each of the plurality of marks has substantially a same length, wherein the information is read based on positions of the plurality of marks.

31. The non-transitory computer-readable storage medium of claim 30, wherein the information is read based on a mark interval between successive marks.

32. A recording medium, comprising:
a plurality of marks in a plurality of recording levels of the recording medium, wherein each of the plurality of marks has substantially a same length, wherein information is encoded based on positions of the plurality of marks.

33. The recording medium of claim 32, wherein the plurality of marks are formed in a spiral pattern.

34. The recording medium of claim 32, wherein the plurality of marks comprises a plurality of voids in the recording medium.

35. The recording medium of claim 32, wherein at least one of distances between successive recording levels is between 4 mm and 9.45 mm.

36. The recording medium of claim 32, wherein the plurality of recording levels are formed between 50 mm and 300 mm from an upper surface of the recording medium.

37. The recording medium of claim 32, wherein the recording medium comprises an optical disc.

38. The recording medium of claim 32, wherein the plurality of marks are formed in twenty or more levels of the recording medium.

39. The recording medium of claim 32, wherein the recording medium comprises a bulk recording medium.
